(19) United States
(12) Patent Application Publication
(10) Pub. No.: US 2025/0335860 A1
(43) Pub. Date: Oct. 30, 2025

(54) PRODUCT QUALITY INCIDENT EARLY WARNING METHOD AND SYSTEM BASED ON CONVOLUTIONAL NEURAL NETWORK

(71) Applicant: China National Institute of Standardization, Beijing (CN)

(72) Inventors: Jingna Yang, Beijing (CN); Yuwei Lu, Beijing (CN); Yunjie Zhi, Beijing (CN)

(21) Appl. No.: 19/019,460

(22) Filed: Jan. 14, 2025

(30) Foreign Application Priority Data
Apr. 24, 2024 (CN) 202410495692.5

(51) Int. Cl. G06Q 10/0639; G06N 3/0464; G06T 7/00

(52) U.S. Cl. CPC G06Q 10/06395; G06N 3/0464; G06T 7/0004

(57) ABSTRACT

Disclosed are a product quality incident early warning method and system based on a convolutional neural network, the method includes: obtaining product quality information, determining product quality compliance, and issuing an early warning for a quality incident; inspecting product quality to obtain production-related parameters and appearance parameters, which are used to determine a production benefit value and a finished product qualification rate of the product, respectively, thereby determining a product quality compliance value; comparing the product quality compliance value with a preset quality compliance threshold to screen out quality anomaly index information of the product, and constructing a product quality anomaly convolutional neural network model to issue an early warning for the quality incident, such that product quality information can be obtained in a more accurate and rapid manner, allowing for quicker and more efficient identification of a product quality incident.

### CROSS-REFERENCE TO RELATED APPLICATION

This application claims priority of Chinese Patent Application No. 202410495692.5, filed on Apr. 24, 2024, the entire contents of which are incorporated herein by reference.

### TECHNICAL FIELD

The present disclosure relates to the technical field of early warning on product quality, and particularly relates to a product quality incident early warning method and system based on a convolutional neural network.

### BACKGROUND

With the rapid development of science and technology, increasingly complex production environments and various market demands, a product manufacturing speed is continuously accelerated and variety of products becomes richer, which makes product quality inspection more limited and challenging. However, the prior art has deficiencies in terms of cost investment, safety, and early warning accuracy, therefore, it is necessary to introduce new technology to improve the safety and accuracy of early warning on product quality, thereby reducing the cost of product quality inspection. Product quality information can be acquired more accurately and quickly using a product quality incident early warning system provided in the present disclosure. By processing data of product quality in multiple dimensions, the acquired product quality incident information becomes more reliable and accurate, which can shorten the product quality inspection time, reduce product quality inspection errors, and make the early warning on product quality more intelligent.

For example, the Chinese invention patent (Publication No.: CN113283818B) discloses a product quality monitoring method for a food product, including establishing a product ship-out database based on product ship-out parameters, and warehousing products in batches; and acquiring data of products in a same batch, and pre-evaluating the products and obtaining data of the products in the same batch. When a deviation between storage stability and product stability falls within a preset range after products leave a factory, it is determined that the storage is qualified, otherwise, the products will be recalled; when the storage is qualified e, a non-storage phase feedback qualification rate will be acquired; when a deviation between the non-storage phase feedback qualification rate and a storage qualification rate falls within a preset range, product processing at the non-storage phase is qualified, otherwise, when the product processing at the non-storage phase is unqualified, corresponding measures should be taken for unqualified products with a highest non-qualification rate, such that the deviation between the non-storage phase feedback qualification rate and the storage qualification rate falls within the preset range, and the product quality monitoring is completed. The product quality monitoring can be performed well through the above operations.

However, during the implementation of the examples in the above invention, the present disclosure identified that the above technical solution had at least the following technical problems: when the above invention monitors the product quality, parameters acquired therefrom are insufficient to support the product quality, and no relevant data, such as product appearance parameters, are available for analyzing the products after leaving the factory. When the products are not inspected from multiple dimensions, inferior products may be shipped out and stored, and product quality inspection data obtained therefrom are inaccurate, and the product quality monitoring will not achieve the desired effects, resulting in poor accuracy of the product quality monitoring.

### SUMMARY

In view of the deficiencies in the prior art, the present disclosure provides a product quality incident early warning method and system based on a convolutional neural network, which can effectively solve the problems stated in the above background.

In order to achieve the above objective, the present disclosure provides the following technical solutions: a first aspect of the present disclosure provides a product quality incident early warning method based on a convolutional neural network, including inspecting quality of a product to obtain quality information of the product, where the quality information includes production-related parameters and appearance parameters; a production benefit value and a finished product qualification rate of the product are determined respectively according to the production-related parameters and the appearance parameters of the product, thereby comprehensively determining a product quality compliance value; comparing the product quality compliance value with a preset quality compliance threshold to screen out quality anomaly index information of the product, and constructing a product quality anomaly convolutional neural network model, thereby facilitating an incident early warning on product quality.

As a further method, the incident early warning on product quality is specifically analyzed as follows: the product quality compliance value is compared with the preset quality compliance threshold, and the quality anomaly index information of the product is screened out when the product quality compliance value is lower than the preset quality compliance threshold, the product quality anomaly convolutional neural network model is constructed, an early warning demand index is obtained by matching the same corresponding to various product quality anomaly convolutional neural network models defined in the product quality database, the early warning demand index of the product is compared with an early warning demand threshold defined in the product quality database; and an incident early warning is issued for the product quality when the early warning demand index exceeds the early warning demand threshold.

As a further method, the product quality compliance value is specifically analyzed as follows:

$$ζ = \frac{\sqrt{ϑ * {k}_{1} + η * {k}_{2}}}{{( e + 1 )}^{2}} ,$$

where ζ represents a product quality compliance value, ϑ represents a production benefit value, η represents a finished product qualification rate, k₁ represents a weight factor corresponding to the production benefit value, k₂ represents a weight factor corresponding to the finished product qualification rate, and e is a natural constant.

As a further method, sensor-related information and historical quality-related information are extracted according to the production-related parameters of the product, and a sensor data influence coefficient and a historical quality data influence coefficient are determined for comprehensive analysis to obtain the production benefit value.

As a further method, the sensor data influence coefficient is specifically analyzed as follows: sensor-related information and historical quality-related information are extracted according to the production-related parameters of the product, a preset production inspection period is divided into various inspection time points according to the sensor-related information of the product, and a production weight, a production vibration frequency, and a production bearing pressure value at each inspection time point are obtained, and a production reference weight, a production identification vibration frequency and a production bearing pressure identification value are extracted from the product quality database for comprehensive analysis to obtain the sensor data influence coefficient.

As a further method, a historical quality data influence coefficient is specifically analyzed as follows: a product defect rate, a product return rate, and a number of customer complaints during a set historical quality inspection period are extracted according to the historical quality-related information, and product defect identification rate and a product return identification rate are extracted from the product quality database for comprehensive analysis of the historical quality data influence coefficient.

As a further method, product image-related information and product treatment-related information are extracted according to the appearance parameters of the product, and a product image data influence coefficient and a product surface treatment influence coefficient are determined for comprehensive analysis to obtain the finished product qualification rate.

As a further method, the product image data influence coefficient is specifically analyzed as follows: a product color RGB value, a product defect ratio and an average product edge smoothness are obtained according to the product image-related information, and a product color reference RGB value, an allowable product defect ratio and an average product edge identification smoothness are extracted from the product quality database for comprehensive analysis of the product image data influence coefficient.

As a further method, the product surface treatment influence coefficient is specifically analyzed as follows: a product appearance treatment glossiness, a product coating treatment thickness and a product color treatment uniformity are extracted according to the product surface treatment-related information of the product, and a product appearance treatment identification glossiness, a product coating treatment identification thickness and a product color treatment identification uniformity are extracted from the product quality database for comprehensive analysis of the product surface treatment influence coefficient.

A second aspect of the present disclosure provides a product quality incident early warning system based on a convolutional neural network, including a product quality information acquisition module being configured to inspect the quality and obtain quality information of a product, where the quality information includes production-related parameters and appearance parameters; a product quality compliance determination module being configured to determine a production benefit value and a finished product qualification rate of the product, respectively, according to the production-related parameters and the appearance parameters of the product, thereby comprehensively determining a product quality compliance value; and a product quality incident early warning module being configured to compare the product quality compliance value with a preset quality compliance threshold to screen out quality anomaly index information of the product, and construct a product quality anomaly convolutional neural network model, thereby facilitating an incident early warning on product quality.

Compared with the prior art, the present disclosure has the following beneficial effects:

(1) The present disclosure provides a product quality incident early warning method and system based on a convolutional neural network, including inspecting quality of a product to obtain production-related parameters and appearance parameters, which are used to determine a production benefit value and a finished product qualification rate of the product, respectively, thereby comprehensively determining a product quality compliance value; comparing the product quality compliance value with a preset quality compliance threshold to screen out quality anomaly index information of the product, and constructing a product quality anomaly convolutional neural network model to issue an early warning for the quality incident of the product, such that product quality information can be obtained in a more accurate and rapid manner, allowing for quicker and more efficient identification of a product quality incident, so as to take corresponding measures and issue an early warning for quality incident of the product.

(2) In the present disclosure, sensor-related information and historical quality-related information are extracted according to the production-related parameters of the product, and a sensor data influence coefficient and a historical quality data influence coefficient are determined for comprehensive analysis to obtain the production benefit value, thereby providing more accurate and reliable data support for subsequent comprehensive analysis of the product quality compliance value, allowing for a comprehensive understanding of the efficiency of production process, and optimizing the management of the production process.

(3) In the present disclosure, product image-related information and product surface treatment-related information are extracted according to appearance parameters of the product, and a product image data influence coefficient and a product surface treatment influence coefficient are determined for comprehensive analysis to obtain the finished product qualification rate, thereby having an understanding of the output control of product after the production process, improving the output qualification rate by taking effective measures in a timely manner, and saving raw material costs and improving the economic benefits of the product in the market.

### BRIEF DESCRIPTION OF THE DRAWINGS

The present disclosure is further described using the accompanying drawings, but the embodiments illustrated through the accompanying drawings do not constitute any limitations on the present disclosure. Those skilled in the art can obtain other drawings based on the accompanying drawings without creative work.

FIG. 1 is a schematic diagram of steps of a method according to the present disclosure.

FIG. 2 is a schematic diagram of connection of modules of a system according to the present disclosure.

### DETAILED DESCRIPTIONS OF THE EMBODIMENTS

The technical solutions in embodiments of the present disclosure are clearly and completely described below in combination with the accompanying drawings in the embodiments of the present disclosure. Apparently, the embodiments described are merely some rather than all of the embodiments of the present disclosure. On the basis of the embodiments in the present disclosure, all other embodiments obtained by those of ordinary skill in the art without making creative efforts all fall within the scope of protection of the present disclosure.

### Embodiment 1

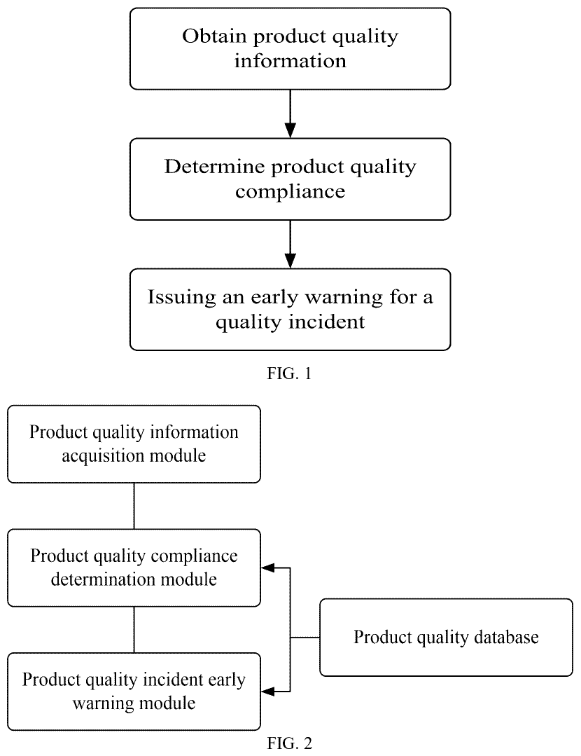

With reference to FIG. 1, this embodiment provides a product quality incident early warning method based on a convolutional neural network, including inspecting quality of a product to obtain quality information of the product, where the quality information includes production-related parameters and appearance parameters, which are used to determine a production benefit value and a finished product qualification rate of the product, respectively, thereby comprehensively determining a product quality compliance value; comparing the product quality compliance value with a preset quality compliance threshold to screen out quality anomaly index information of the product, and constructing a product quality anomaly convolutional neural network model, thereby facilitating an incident early warning on product quality.

A production reference weight, a production identification vibration frequency and a production bearing pressure identification value are extracted from the product quality database.

In one specific embodiment, a mathematical model between sensor data and sensor compliance data can be established based on physical laws and engineering principles, and a sensor data influence coefficient can be obtained through model analysis.

A sensor data influence coefficient is specifically analyzed as follows:

sensor-related information and historical quality-related information are extracted according to the production-related parameters of the product. It should be explained that the sensor-related information and the historical quality-related information can be directly extracted from a product quality database.

A preset production inspection period is divided into various inspection time points according to the sensor-related information of the product, and a production weight, a production vibration frequency, and a production bearing pressure value at each inspection time point are obtained, where the production weight can be directly measured using an electronic scale; the production vibration frequency can be measured through an electrical measurement method by converting changes in the production vibration frequency into an electrical signal, which is amplified by a circuit, and then displayed and recorded to obtain a production vibration frequency value; and the production bearing pressure value is measured using a pressure sensor.

In this embodiment, a sensor data influence coefficient is obtained through comprehensive analysis of the production weight, the production vibration frequency, and the production bearing pressure value at each inspection time point, which is used to determine a numerical value of the sensor data influence. A sensor data influence coefficient is obtained through a more accurate calculation method in this embodiment, with a specific expression as follows:

$$∃ = {arctan [ e + {\sum }_{i = 1}^{m} ( \frac{\vert {W}_{i} - {W}^{′} \vert}{{W}^{′}} * {a}_{1} + \frac{{V}_{i}}{{V}^{′}} * {a}_{2} + \frac{{P}^{′}}{{P}_{i}} * {a}_{3} ) ]}^{\frac{1}{2}} ,$$

where ∃ is defined as a sensor data influence coefficient. In this embodiment, the stability of the production weight will affect the stability of sensor data. When the production weight changes or fluctuates greatly, data outputted by the sensor may also fluctuate, resulting in unstable measurement results; when the production vibration frequency is too high, the product quality could be unqualified, which will make the sensor unable to respond in time or record vibration data accurately, resulting in reduced precision or poor stability of the measurement results; when the production bearing pressure value is too low, the product could suffer deformation, rupture, or failure of the product during use, reducing overall production efficiency. In summary, in the product quality inspection process, it is very necessary to give comprehensive consideration to the production weight, the production vibration frequency, and the production bearing pressure value, such that the sensor data can be monitored to improve the production efficiency of the product.

i is a numbering of each inspection time point, i=1,2,3, . . . , m, and m is defined as a total number of inspection time points.

Wᵢ is defined as a production weight at an i^{th} inspection time point, where the production weight at each inspection time point refers to an actual weight of the product at a specific inspection time point during production, and the accuracy of the production weight is crucial to ensuring product quality and controlling production costs.

W′ is defined as the production reference weight, and specifically refers to an optimal suitable production weight.

Vᵢ is defined as a production vibration frequency at the i^{th} inspection time point, where the production vibration frequency refers to a frequency of vibrations generated by the product during production. By measuring and analyzing the production vibration frequency, the stability and reliability of the product during production can be evaluating, and possible product quality problems can be predicted.

V′ is defined as a production identification vibration frequency, and specifically refers to a specified maximum value for the production vibration frequency.

Pᵢ is defined as a production bearing pressure value at the i^{th} inspection time point, where the production bearing pressure value refers to a maximum pressure that the product can bear during production. The production bearing pressure value is usually closely related to structural strength, sealing performance and safety of the product. By measuring the production bearing pressure value, it can be ensured that the product can operate in a safe and stable manner under normal working conditions.

P′ is defined as the production bearing pressure identification value, and specifically refers to a minimum value set for the product that can bear during production.

a₁ represents a correction factor corresponding to a predefined production weight, a₂ represents a correction factor corresponding to a predefined production vibration frequency, a₃ represents a correction factor corresponding to a predefined production bearing pressure value, and e is a natural constant.

Further, a historical quality data influence coefficient is specifically analyzed as follows:

a product defect rate, a product return rate, and a number of customer complaints during a set historical quality inspection period are extracted according to the historical quality-related information, where the product defect rate can be calculated and obtained by randomly sampling a certain number of products from a production line or a warehouse, and recording a number of defective products; the product return rate can be calculated and obtained by logging into a product sales backend management page and obtaining a number of product return orders during the set historical quality inspection period; and the number of customer complaints can be obtained by logging into a product management backend page and extracting customer complaint data for statistics.

A product defect identification rate and a product return identification rate are extracted from the product quality database.

In one specific embodiment, a mathematical relationship between historical quality data and historical quality compliance data can be established using a regression analysis method, and a regression coefficient can be calculated to quantify the influence of historical quality data, so as to obtain the historical quality data influence coefficient.

In this embodiment, the historical quality data influence coefficient is obtained through comprehensive analysis of the product defect rate, the product return rate, and the number of customer complaints, which are used to determine a numerical value of the historical quality data influence coefficient. The historical quality data influence coefficient is obtained through a more accurate calculation method in this embodiment, with a specific expression as follows:

$$λ = \frac{3 - e}{lg [ \frac{{F}^{′}}{F} * {a}_{4} + \frac{{R}^{′}}{R} * {a}_{5} + {( e - 1 )}^{\frac{1}{B * {a}_{6}}} ]} ,$$

where λ is defined as the historical quality data influence coefficient. The product defect rate can reflect a quality status of the product during the historical quality inspection period, and fluctuation trend and change law of the product quality can be identified by comparing product defect rates across different inspection period; when the product defect rate remains high for a period of time, it means that there are persistent issues or potential risks during production. The product return rate can reflect customer satisfaction and acceptance of the product; and when the return rate shows an upward trend during the historical quality inspection period, it may suggest that the product has quality problems, and the product quality needs to be improved as early as possible. The number of customer complaints can directly reflect customer feedback on the product; and when the number of customer complaints increases continuously during the historical quality inspection period, it means that the product quality does not meet expectations, and the quality problems during production have not been solved promptly. In summary, in order to mitigate the negative impact of the product defect rate, the product return rate, and the number of customer complaints on product quality, it is necessary to give comprehensive consideration to the parameters, which can not only assist a product quality inspector in evaluating the product quality but also provide direction and suggestions for improving the product quality.

F is defined as a product defect rate during the set historical quality inspection period, where the product defect rate refers to a proportion of products with defects during the historical quality inspection period. Defects refer to a situation where the product fails to meet design specifications, performance standards, or has quality problems, and the indicator is conducive to understanding the stability and consistency of product quality during the historical quality inspection period, thereby providing a basis for the product quality inspector to improve the product quality.

F′ is defined as a product defect identification rate, and specifically refers to a maximum allowable value of the product defect rate.

R is defined as a product return rate during the set historical quality inspection period, where the product return rate refers to a proportion of returned products by customers for various reasons to a total number of products sold during the historical quality inspection period. By analyzing the product return rate, the product quality inspector can gain a clear understanding of the potential quality issues and improve the production process accordingly, thereby improving the product quality.

R′ is defined as a product return identification rate, which is a maximum acceptable value of the product return rate.

B is defined as a number of customer complaints during the set historical quality inspection period, where the number of customer complaints refers to a number of complaints raised by customers about the product quality problems. By counting and analyzing the number of customer complaints, the product quality inspector can identify key issues about which the customers complain about, and work out targeted measures for product quality improvement, thereby improving customer experience and brand reputation.

a₄ represents a correction factor corresponding to a predefined product defect rate, a₅ represents a correction factor corresponding to a predefined product return rate, a₆ represents a historical quality impact factor corresponding to a predefined number of customer complaints, and e is a natural constant.

In one embodiment, the production benefit value can be evaluated by establishing system model using simulation software, inputting different production efficiency indicators to the system model to simulate system behavior, and then comprising simulation results.

In this embodiment, the production benefit value is obtained through comprehensive analysis of a sensor data influence coefficient and the historical quality data influence coefficient, which are used to determine the production benefit value. The production benefit value is obtained through a more accurate calculation method in this embodiment, with a specific expression as follows:

$$ϑ = [ {( \frac{1}{e - 1} )}^{∃ * {b}_{1} + λ * {b}_{2}} ] ,$$

where ϑ is defined as the production benefit value. In this embodiment, when an influence coefficient of the sensor data on production efficiency is high, it means that the sensor data have a negative impact on improving the production efficiency, which is not conducive to discovering a potential quality anomaly during production; in addition, the lower the historical quality data influence coefficient is, the more beneficial it is for the product quality inspector to identify the quality problem, figure out a root cause of the quality problem and take action; further, the historical quality data influence coefficient can be used to predict a future product quality trend, thereby improving production efficiency. In summary, by integrating a sensor data influence coefficient and the historical quality data influence coefficient, a comprehensive and accurate production benefit evaluation system is established for product quality inspection, and provide strong support for improving product quality and optimizing production process of the product.

∃ is defined as a sensor data influence coefficient, and refers to a value obtained through comprehensive analysis of the production weight, the production vibration frequency, and the production bearing pressure value.

λ is defined as the historical quality data influence coefficient, and refers to a value of the historical quality data influence coefficient through comprehensive analysis of the product defect rate, the product return rate, and the number of customer complaints.

b₁ represents a weight factor corresponding to the sensor data influence coefficient, b₂ represents a weight factor corresponding to the historical quality data influence coefficient, and e is a natural constant.

Further, a product image data influence coefficient is specifically analyzed as follows:

product image-related information and product surface treatment-related information are extracted according to appearance parameters of the product. It should be explained that the product image-related information and the product surface treatment-related information can be directly obtained from the product quality database.

a product color RGB value, a product defect ratio and an average product edge smoothness are obtained according to the product image-related information, where an RGB value of the corresponding product color can be displayed on a computer through a color selection tool, the product defect ratio is obtained and calculated by making statistics of a total number of defective products and comparing with a total number of products, and the average product edge smoothness is obtained using image processing image, and the smoothness is calculated by analyzing pixel distribution and changes of an product edge.

A product color reference RGB value, an allowable product defect ratio and an average product edge identification smoothness are extracted from the product quality database.

In one specific embodiment, results related to image data can be predicted by training a machine learning model, a supervised learning algorithm is adopted to learn a relationship between image features and target product image data through training data, and the product image data influence coefficient is then evaluated.

In this embodiment, the product image data influence coefficient is obtained through comprehensive analysis of the product color RGB value, the product defect ratio and the average product edge smoothness, which are used to determine a numerical value of the historical quality data influence coefficient. The product image data influence coefficient is obtained through a more accurate calculation method in this embodiment, with a specific expression as follows:

$$α = ln ( 1 + \frac{\frac{\vert CO - {CO}^{′} \vert}{{CO}^{′}} * {d}_{1} + \frac{AR}{{AR}^{′}} * {d}_{2}}{\sqrt{e}} + \frac{{ED}^{′}}{ED} * {d}_{3} ) ,$$

where α is defined as the product image data influence coefficient. In this embodiment, when the product color RGB value is inaccurate or abnormal, it may cause the product color to deviate from an actual color, such that the customers are unable to gain an accurate understanding of a true color of the product, and clarity and detail display of the product will also be affected; when the product defect ratio is too high, customer interest and willingness to purchase the product will be reduced, making the product quality inspector difficult to accurately assess an overall product quality; and when the average product edge smoothness is bad, customer interest in purchasing the product and the product performance will be affected, resulting in a decline in product quality. In summary, the product color RGB value, the product defect ratio and the average product edge smoothness have an important impact on the product image data. In order to ensure the accuracy and reliability of product image data, the factors should be strictly controlled and optimized during the image processing and analysis to minimize any negative impact from the factors.

CO is defined as the product color RGB value, and refers to a method of defining the product color by adjusting a brightness of three primary colors, that is, red, green and blue. The RGB value is a triplet, for example, (255, 0, 0) represents red, (0, 255, 0) represents green. In this embodiment, the RGB value refers to a color value represented by triplet data.

CO′ is defined as a product color reference RGB value, and refers to the standard RGB value specified for the product color.

AR is defined as the product defect ratio, and refers to a ratio of defects or defective products to the total products, which is one of the important criteria for measuring the product quality, the lower the product defect ratio is, the better the product quality becomes.

AR′ is defined as the allowable product defect ratio, and refers to a maximum allowable defect ratio when the product defects are analyzed.

ED is defined as the average product edge smoothness, and refers to the product edge smoothness after production, the higher the average smoothness is, the smoother the product edge becomes, and the better the overall product quality becomes, thereby contributing to better usability.

ED′ is defined as a product edge identification smoothness, and refers to a minimum value specified for the product edge smoothness.

d₁ represents a correction factor corresponding to a predefined product color RGB value, d₂ represents a correction factor corresponding to a predefined product defect ratio, d₃ represents a correction factor corresponding to a predefined average product edge smoothness, and e is a natural constant.

A product surface treatment influence coefficient is specifically analyzed as follows:

a product appearance treatment glossiness, a product coating treatment thickness and a product color treatment uniformity are extracted according to the product surface treatment-related information of the product, where the product appearance treatment glossiness is evaluated by an angle method that makes an intensity of light reflected by the product surface at a specific angle; the product coating treatment thickness is measured non-destructively using an ultrasonic thickness gauge, and reflection time of ultrasonic pulses between a coating and a substrate to facilitate the calculation of the coating thickness; and the product color treatment uniformity is assessed using a colorimeter, which reads different color values to reflect difference in object color, thereby determining the uniformity of product color treatment.

A product appearance treatment identification glossiness, a product coating treatment identification thickness and a product color treatment identification uniformity are extracted from the product quality database.

In one specific embodiment, the product surface treatment influence coefficient can be determined by establishing market acceptance and customer satisfaction of the product surface treatment through market research, and the information is helpful to evaluate influence of the product surface treatment.

In this embodiment, the product surface treatment influence coefficient is obtained through comprehensive analysis of the product appearance treatment glossiness, the product coating treatment thickness and the product color treatment uniformity, which are used to determine a numerical value of the product surface treatment influence coefficient. The product surface treatment influence coefficient can also be obtained through a more accurate calculation method in this embodiment, with a specific expression as follows:

$$β = \frac{3 e}{lg ( 1 + \frac{L}{{L}^{′}} * {f}_{1} + \frac{C}{{C}^{′}} * {f}_{2} + \frac{J}{{J}^{′}} * {f}_{3} )} ,$$

where β represents a product surface treatment influence coefficient. In this embodiment, the product appearance treatment glossiness directly determines a surface texture of the product, the product with a higher appearance glossiness usually gives a sense of luxury and exquisiteness, the higher the product appearance treatment glossiness is, the better the product surface treatment becomes, and the product appearance treatment glossiness is directly associated with an overall attractiveness of the product surface; the product coating treatment thickness directly determines the capability of coating to protect the substrate, and has an significant impact on the durability, service life, and surface stability of the product, therefore, an improper coating thickness will have a negative impact on the product surface treatment; and the product color treatment uniformity is associated with an overall harmony of the product surface, and uneven color treatment can make the product surface appear messy and reduce the overall aesthetics of the product. In summary, the product appearance treatment glossiness, the product coating treatment thickness and the product color treatment uniformity directly affects the product surface treatment influence coefficient, thereby affecting overall evaluation and acceptance of the products by the customers.

L is defined as the product appearance treatment glossiness, and refers to reflection effect of a smooth surface at a specific angle. Generally, the higher the product appearance treatment glossiness is, the stronger the ability of the product surface to reflect light becomes, which gives a brighter, more vivid appearance.

L′ is defined as a product appearance treatment identification glossiness, and refers to a minimum allowable value for product appearance treatment glossiness.

C is defined as the product coating treatment thickness, and refers to a thickness of the coating applied to a surface of the substrate. It is an important indicator to characterize the quality of the coating and the anti-corrosion protection ability. A thickness of the product coating is directly associated with use effect and service life of the product coating. A coating that is too thin easily leads to surface wear, peeling, or susceptibility to external corrosion.

C′ is defined as the product coating identification thickness, and refers to a minimum allowable value when the product coating treatment thickness is analyzed.

J is defined as the product color treatment uniformity, and is mainly used for describing distribution and consistency of a surface color of the product. A color treatment with higher uniformity indicates that the color is evenly distributed on the product surface, without color difference or color spot, which is crucial for the product. The product color treatment uniformity is affected by many factors, including coating process, coating thickness, raw material quality, environmental factors, and the like.

J′ is defined as product color treatment identification uniformity, and refers to a minimum allowable value for the product color treatment uniformity.

f₁ represents a correction factor corresponding to a predefined product appearance treatment glossiness, f₂ represents a correction factor corresponding to a predefined coating treatment thickness, f₃ represents a correction factor corresponding to a predefined product color treatment uniformity, and e is a natural constant.

Further, in one specific embodiment, the finished product qualification rate of the product can be obtained by randomly selecting a certain number of product samples from a production line through a sample inspection method, and testing and evaluating according to predetermined inspection standards and methods.

In this embodiment, the finished product qualification rate is obtained through comprehensive analysis of the product image data influence coefficient and the product surface treatment influence coefficient, which are used to determine the production benefit value. The product surface treatment influence coefficient is obtained through a more accurate calculation method in this embodiment, with a specific expression as follows:

$$η = arctan ( \frac{1}{α * {g}_{1} + β * {g}_{2}} ) ,$$

where η represents a finished product qualification rate. In this embodiment, the product image data impact coefficient mainly involves data of product appearance and color; when there is a significant difference between the product image data and the actual product or the image data is incomplete, it may result in a deviation in the finished product qualification rate, thereby affecting the evaluation of product quality. The product surface treatment impact coefficient mainly focuses on the product surface treatment quality, the surface treatment is directly associated with appearance, service life, and durability of the product; when the product coating treatment thickness is uneven or the glossiness is insufficient, it may result in peeling, discoloration or other problems during use, thereby affecting the overall quality and the finished product qualification rate of the product; and when the product surface treatment process involves any contamination or defect, the finished product qualification rate will also be reduced. Therefore, in order to improve the finished product qualification rate, it is necessary to give full consideration to the product image data impact coefficient and the product surface treatment impact coefficient.

α represents a product image data impact coefficient, and is obtained through comprehensive analysis of the product color RGB value, the product defect ratio and the average product edge smoothness.

β represents a product surface treatment influence coefficient, and is obtained through comprehensive analysis of the product appearance treatment glossiness, the product coating treatment thickness and the product color treatment uniformity.

g₁ represents a weight factor corresponding to the product image data influence coefficient, and g₂ represents a weight factor corresponding to the product surface treatment influence coefficient.

In one specific embodiment, the product quality compliance value can be obtained by an online inspection method, specifically, automated equipment and sensor can be used to inspect the product in real time, and the product quality compliance value can be then determined.

The product quality compliance value is obtained through comprehensive analysis of the production benefit value and the finished product qualification rate of the product. In this embodiment, the product quality compliance value is obtained through a more accurate calculation method in this embodiment, with a specific expression as follows:

$$ζ = \frac{\sqrt{ϑ * {k}_{1} + η * {k}_{2}}}{{( e + 1 )}^{2}} ,$$

where ζ represents a product quality compliance value. In this embodiment, the production benefit value involves a plurality of aspects such as production efficiency and product quality. During production, practices such as reducing the quality of raw material, simplifying production process or shortening inspection time may lead to low production efficiency, which in turn could reduce the product quality or may even make the finished product unable to meet relevant regulations, standards and requirements, thereby affecting the product quality compliance value. The finished product qualification rate directly reflects the stability and reliability of product quality, and a lower finished product qualification rate could result in a large number of unqualified products, which will greatly reduce the product quality compliance. In summary, the production benefit value and the finished product qualification rate are important factors affecting the product quality compliance value, and need to be comprehensively considered and optimized during production, so as to improve the product quality compliance value.

ϑ is defined as the production benefit value, and is obtained through comprehensive analysis of a sensor data influence coefficient and the historical quality data influence coefficient.

η is defined as the finished product qualification rate, and is obtained through comprehensive analysis of the product image data influence coefficient and the product surface treatment influence coefficient.

k₁ represents a weight factor corresponding to the production benefit value, k₂ represents a weight factor corresponding to the finished product qualification rate, and e is a natural constant.

Further, the incident early warning on product quality is specifically analyzed as follows:

the product quality compliance value is compared with a preset quality compliance threshold; when the product quality compliance value is lower than the preset quality compliance threshold, it may lead to a decline in customer trust in the brand, thereby damaging reputation and image of the brand. The unqualified product usually has the problems of poor performance and low safety, which will directly reduce customer satisfaction. In addition, return and recall of the unqualified product will also generate additional costs, affecting the product profitability.

The quality anomaly index information of the product is screened, and a product quality anomaly convolutional neural network model is constructed, with specific steps as follows: dividing the quality anomaly index information into a training set and a validation set; performing feature transformation processing on the training set and the validation set, such as logarithmic transformation and polynomial transformation, to enhance the representational ability of the product quality anomaly features; designing a number of layers, convolution kernel size, stride, padding, and other parameters of the convolutional neural network model, adding pooling layer and fully connected layer to reduce a size of the feature map and decrease the complexity of model; adjusting hyperparameters using the validation set, training the model using the training set, and validating the training on the validation set to adjust the model parameters; and finally building the product quality anomaly convolutional neural network model in combination with the forecast results of multiple models.

An early warning demand index is obtained by matching the same corresponding to various product quality anomaly convolutional neural network models defined in the product quality database, with specific process as follows: converting output of each of the product quality anomaly convolutional neural network models into a format of unified warning degree, such as a probability value between 0 and 1 or a specific score range; and fusing the warning degree values outputted by each model to obtain a comprehensive warning degree value. A fusion method includes simple average, weighted average, maximum, minimum, or other more complex fusion strategies, depending on the performance, correlation, and business need of the product quality anomaly convolutional neural network model. A comprehensive warning degree value is a continuous or discrete value. In order to determine whether the product requires an early warning, one or more early warning thresholds must be set, and the thresholds can be determined based on historical data, business needs, and risk tolerance; and the early warning demand indexes for the product are finally matched according to the fused comprehensive warning degree value and the set warning thresholds.

The early warning demand index of the product is compared with an early warning demand threshold defined in the product quality database; and when the early warning demand index exceeds the early warning demand threshold, an incident early warning for the product quality will be triggered.

It should be explained that the early warning demand threshold is defined as 5 in a specific embodiment, when the early warning demand index is 2, it means the early warning demand index is lower than the early warning demand threshold, in which case, the quality of the product is in a qualified state, and an early warning for the quality is not required; and when the early warning demand index is 8, it means the early warning demand index is greater than the early warning demand threshold, in which case, the quality of the product is in an unqualified state, and an early warning for the quality is required.

### Embodiment 2

With reference to FIG. 2, this embodiment provides a product quality incident early warning system based on a convolutional neural network, including a product quality information acquisition module, a product quality compliance determination module, and a product quality incident early warning module.

The product quality incident early warning system based on a convolutional neural network, further includes a product quality database, which is configured to store the production reference weight, the production identification vibration frequency, the production bearing pressure identification value, the product defect identification rate, the product return identification rate, the product color reference RGB value, the allowable product defect ratio, the average product edge identification smoothness, the product appearance treatment identification glossiness, the product coating treatment identification thickness, the product color treatment identification uniformity, and early warning demand indexes and early warning demand thresholds corresponding to various product quality anomaly convolutional neural network models.

The product quality information acquisition module is connected to the product quality compliance determination module, the product quality compliance determination module is connected to the product quality incident early warning module, and the product quality compliance determination module and the product quality incident early warning module are connected to the product quality database.

The product quality information acquisition module is configured to inspect the quality and obtain quality information of a product, where the quality information includes production-related parameters and appearance parameters.

The product quality compliance determination module is configured to determine a production benefit value and a finished product qualification rate of the product, respectively, according to the production-related parameters and the appearance parameters of the product, thereby comprehensively determining a product quality compliance value.

The product quality incident early warning module is configured to compare the product quality compliance value with a preset quality compliance threshold to screen out quality anomaly index information of the product, and construct a product quality anomaly convolutional neural network model, thereby facilitating an incident early warning on product quality.

The above description is only examples and explanation of the structure of the present disclosure, those skilled in the art may make various modifications or additions to the described specific examples, or substitute them with a similar method. These modifications, additions or substitutions shall fall within the protection scope of the present disclosure, as long as they do not depart from the structure of the present disclosure or are out of the scope as defined by the appended claims.

1. A product quality incident early warning method based on a convolutional neural network, comprising:
inspecting quality and obtain quality information of a product, wherein the quality information comprises production-related parameters and appearance parameters;
determining a production benefit value and a finished product qualification rate of the product, according to the production-related parameters and the appearance parameters of the product, and determining a product quality compliance value based on the production benefit value and the finished product qualification rate of the product; and
comparing the product quality compliance value with a preset quality compliance threshold to screen out quality anomaly index information of the product, and constructing a product quality anomaly convolutional neural network model, and issuing an incident early warning for the product quality; wherein
the issuing an incident early warning for the product quality comprises:
comparing the product quality compliance value with the preset quality compliance threshold, and screening out the quality anomaly index information of the product when the product quality compliance value is lower than the preset quality compliance threshold, constructing the product quality anomaly convolutional neural network model, obtaining an early warning demand index by matching early warning demand indexes corresponding to various product quality anomaly convolutional neural network models defined in a product quality database, comparing the early warning demand index of the product with an early warning demand threshold defined in the product quality database; and issuing an incident early warning for the product quality when the early warning demand index exceeds the early warning demand threshold;
the product quality compliance value is calculated as follows:
$$ζ = \frac{\sqrt{ϑ * {k}_{1} + η * {k}_{2}}}{{( e + 1 )}^{2}} ,$$
wherein, ζ represents a product quality compliance value, ϑ represents a production benefit value, η represents a finished product qualification rate, k₁ represents a weight factor corresponding to the production benefit value, k₂ represents a weight factor corresponding to the finished product qualification rate, and e is a natural constant;
sensor-related information and historical quality-related information are extracted according to the production-related parameters of the product, and a sensor data influence coefficient and a historical quality data influence coefficient are determined for comprehensive analysis to obtain the production benefit value;
the production benefit value is calculated as follows:
$$ϑ = [ {( \frac{1}{e - 1} )}^{∃ * {b}_{1} + λ * {b}_{2}} ] ,$$
wherein, ϑ represents a production benefit value, ∃ represents a sensor data influence coefficient, λ represents a historical quality data influence coefficient, b₁ represents a weight factor corresponding to the sensor data influence coefficient, b₂ represents a weight factor corresponding to the historical quality data influence coefficient, and e is a natural constant;
product image-related information and product surface treatment-related information are extracted according to the appearance parameters of the product, and a product image data influence coefficient and a product surface treatment influence coefficient are determined for comprehensive analysis to obtain the finished product qualification rate; wherein
the finished product qualification rate is calculated as follows:
$$η = arc tan ( \frac{1}{α * {g}_{1} + β * {g}_{2}} ) ,$$
wherein, η represents a finished product qualification rate, α represents a product image data impact coefficient, β represents a product surface treatment influence coefficient, g₁ represents a weight factor corresponding to the product image data influence coefficient, and g₂ represents a weight factor corresponding to the product surface treatment influence coefficient; wherein
the sensor data influence coefficient is specifically analyzed as follows:
extracting the sensor-related information and the historical quality-related information according to the production-related parameters of the product;
dividing a preset production inspection period into various inspection time points according to the sensor-related information of the product, and obtaining a production weight, a production vibration frequency, and a production bearing pressure value of the product at each inspection time point; and
extracting a production reference weight, a production identification vibration frequency and a production bearing pressure identification value of the product from the product quality database for comprehensive analysis to obtain the sensor data influence coefficient;
the historical quality data influence coefficient is specifically analyzed as follows:
extracting a product defect rate, a product return rate, and a number of customer complaints during a set historical quality inspection period according to the historical quality-related information; and
extracting a product defect identification rate and a product return identification rate from the product quality database for comprehensive analysis of the historical quality data influence coefficient;
the product image data influence coefficient is specifically analyzed as follows:
obtaining a product color RGB value, a product defect ratio and an average product edge smoothness according to the product image-related information of the product; and
extracting a product color reference RGB value, an allowable product defect ratio and an average product edge identification smoothness from the product quality database for comprehensive analysis of the product image data influence coefficient;
the product surface treatment influence coefficient is specifically analyzed as follows:
extracting a product appearance treatment glossiness, a product coating treatment thickness and a product color treatment uniformity according to the product surface treatment-related information of the product; and
extracting a product appearance treatment identification glossiness, a product coating treatment identification thickness and a product color treatment identification uniformity from the product quality database for comprehensive analysis of the product surface treatment influence coefficient.

2. A system using the product quality incident early warning method based on a convolutional neural network according to claim 1, comprising:
a product quality information acquisition module being configured to inspect the quality and obtain quality information of a product, wherein the quality information comprises production-related parameters and appearance parameters;
a product quality compliance determination module being configured to determine a production benefit value and a finished product qualification rate of the product according to the production-related parameters and the appearance parameters of the product, and determine a product quality compliance value based on the production benefit value and the finished product qualification rate of the product; and
a product quality incident early warning module being configured to compare the product quality compliance value with a preset quality compliance threshold to screen out quality anomaly index information of the product, and construct a product quality anomaly convolutional neural network model, and issue an incident early warning for the product quality; wherein
the product quality incident early warning module being configured to:
compare the product quality compliance value with the preset quality compliance threshold, and screen out the quality anomaly index information of the product when the product quality compliance value is lower than the preset quality compliance threshold, construct the product quality anomaly convolutional neural network model, obtain an early warning demand index by matching early warning demand indexes corresponding to various product quality anomaly convolutional neural network models defined in a product quality database, compare the early warning demand index of the product with an early warning demand threshold defined in the product quality database; and issue an incident early warning for the product quality when the early warning demand index exceeds the early warning demand threshold;
the product quality compliance value is calculated as follows:
$$ζ = \frac{\sqrt{ϑ * {k}_{1} + η * {k}_{2}}}{{( e + 1 )}^{2}} ,$$
wherein, ζ represents a product quality compliance value, ϑ represents a production benefit value, η represents a finished product qualification rate, k₁ represents a weight factor corresponding to the production benefit value, k₂ represents a weight factor corresponding to the finished product qualification rate, and e is a natural constant;
sensor-related information and historical quality-related information are extracted according to the production-related parameters of the product, and a sensor data influence coefficient and a historical quality data influence coefficient are determined for comprehensive analysis to obtain the production benefit value;
the production benefit value is calculated as follows:
$$ϑ = [ {( \frac{1}{e - 1} )}^{∃ * {b}_{1} + λ * {b}_{2}} ] ,$$
wherein, ϑ represents a production benefit value, ∃ represents a sensor data influence coefficient, λ represents a historical quality data influence coefficient, b₁ represents a weight factor corresponding to the sensor data influence coefficient, b₂ represents a weight factor corresponding to the historical quality data influence coefficient, and e is a natural constant;
product image-related information and product surface treatment-related information are extracted according to the appearance parameters of the product, and a product image data influence coefficient and a product surface treatment influence coefficient are determined for comprehensive analysis to obtain the finished product qualification rate; wherein
the finished product qualification rate is calculated as follows:
$$η = arc tan ( \frac{1}{α * {g}_{1} + β * {g}_{2}} ) ,$$
wherein, η represents a finished product qualification rate, α represents a product image data impact coefficient, β represents a product surface treatment influence coefficient, g₁ represents a weight factor corresponding to the product image data influence coefficient, and g₂ represents a weight factor corresponding to the product surface treatment influence coefficient; wherein
the sensor data influence coefficient is specifically analyzed as follows:
extracting the sensor-related information and the historical quality-related information according to the production-related parameters of the product;
dividing a preset production inspection period into various inspection time points according to the sensor-related information of the product, and obtaining a production weight, a production vibration frequency, and a production bearing pressure value of the product at each inspection time point; and
extracting a production reference weight, a production identification vibration frequency and a production bearing pressure identification value of the product from the product quality database for comprehensive analysis to obtain the sensor data influence coefficient;
the historical quality data influence coefficient is specifically analyzed as follows:
extracting a product defect rate, a product return rate, and a number of customer complaints during a set historical quality inspection period according to the historical quality-related information; and
extracting a product defect identification rate and a product return identification rate from the product quality database for comprehensive analysis of the historical quality data influence coefficient;
the product image data influence coefficient is specifically analyzed as follows:
obtaining a product color RGB value, a product defect ratio and an average product edge smoothness according to the product image-related information of the product; and
extracting a product color reference RGB value, an allowable product defect ratio and an average product edge identification smoothness from the product quality database for comprehensive analysis of the product image data influence coefficient;
the product surface treatment influence coefficient is specifically analyzed as follows:
extracting a product appearance treatment glossiness, a product coating treatment thickness and a product color treatment uniformity according to the product surface treatment-related information of the product; and
extracting a product appearance treatment identification glossiness, a product coating treatment identification thickness and a product color treatment identification uniformity from the product quality database for comprehensive analysis of the product surface treatment influence coefficient.
